(19) United States
(12) Patent Application Publication
(10) Pub. No.: US 2021/0008706 A1
(43) Pub. Date: Jan. 14, 2021

(54) PNEUMATIC TOOL

(71) Applicant: Basso Industry Corp., Taichung (TW)

(72) Inventor: Chin-Cheng LI, Taichung (TW)

(21) Appl. No.: 16/921,938

(22) Filed: Jul. 7, 2020

(30) Foreign Application Priority Data
Jul. 10, 2019 (TW) 108124374

(51) Int. Cl. B25F 5/02; B25B 21/00; B23B 45/04

(52) U.S. Cl. CPC B25F 5/02; B25B 23/1453; B23B 45/04; B25B 21/00

(57) ABSTRACT

A pneumatic tool including a gun body, a rotating valve, a valve bushing and a trigger set is provided. The rotating valve is disposed at the gun body and includes at least one opening. The valve bushing sleeves the rotating valve and includes two ports. The trigger set is operably disposed at the gun body and is operably coupled to the rotating valve. A rotation of the trigger set causes the rotating valve to rotate to a first position relative to the valve bushing such that the at least one opening of the rotating valve is aligned to one of the two ports, and the rotation of the trigger set causes the rotating valve to rotate to a second position relative to the valve bushing such that the at least one opening of the rotating valve is aligned to the other one of the two ports.

### RELATED APPLICATIONS

This application claims priority to Taiwan Application Serial Number 108124374, filed Jul. 10, 2019, which is herein incorporated by reference.

### BACKGROUND

### Technical Field

The present disclosure relates to a pneumatic tool. More particularly, the present disclosure relates to a pneumatic tool capable of rotating in a clockwise direction and a counterclockwise direction.

### Description of Related Art

The improvement of the technology increases the technique development of tools, and tools adapting power or automatic tools replace the conventional manual tools and are widely used in daily life, which increases the convenience in human world. A pneumatic tool uses the gas to drive the mechanism, and common pneumatic tools include wrenches and screw drivers. The torque continuously outputted by the pneumatic tool can rotate the element; as a result, the time and the labor can be saved.

A conventional pneumatic tool can be switched between a clockwise mode for rotating in a clockwise direction and a counterclockwise mode for rotating in a counterclockwise direction. In order to achieve the function, a swinging lever or a pushing lever is disposed in addition to the trigger. Through the operation of the swinging lever or the pushing lever, the rotating valve of the pneumatic tool can be rotated to switch the modes. However, in configuration, such a conventional pneumatic tool needs other elements to rotate the rotating valve, and, in operation, different elements have to be operated to switch the modes or to activate the tool; consequently, the conventional pneumatic tool is not convenient, and there is a need to improve the structure thereof.

Based on the abovementioned problems, how to efficiently improve the structure of the pneumatic tool to increase the convenience becomes a pursuit target for practitioners.

### SUMMARY

According to one aspect of the present disclosure, a pneumatic tool including a gun body, a rotating valve, a valve bushing and a trigger set is provided. The rotating valve is disposed at the gun body and includes at least one opening. The valve bushing sleeves the rotating valve and includes two ports. The trigger set is operably disposed at the gun body and is operably coupled to the rotating valve. A rotation of the trigger set causes the rotating valve to rotate to a first position relative to the valve bushing such that the at least one opening of the rotating valve is aligned to one of the two ports, and the rotation of the trigger set causes the rotating valve to rotate to a second position relative to the valve bushing such that the at least one opening of the rotating valve is aligned to the other one of the two ports.

According to another aspect of the present disclosure, a pneumatic tool including a gun body, a motor, a rotating valve and a trigger set is provided. The gun body includes a receiving space, a first gas channel and a second gas channel. The first gas channel and the second gas channel communicate with the receiving space, respectively. The motor is received in the receiving space. The rotating valve is disposed at the gun body and includes at least one opening. The trigger set is operably disposed at the gun body and is operably coupled to the rotating valve. A rotation of the trigger set causes the rotating valve to rotate to a first position such that the at least one opening of the rotating valve communicates with the first gas channel, and pressing the trigger set allows a gas to enter the first gas channel from the at least one opening thereby driving the motor to rotate in a clockwise direction. The rotation of the trigger set causes the rotating valve to rotate to a second position such that the at least one opening of the rotating valve is communicates with the second gas channel, and pressing the trigger set allows the gas to enter the second gas channel from the at least one opening thereby driving the motor to rotate in a counterclockwise direction.

### BRIEF DESCRIPTION OF THE DRAWINGS

The disclosure can be more fully understood by reading the following detailed description of the embodiments, with reference made to the accompanying drawings as follows:

FIG. 1 shows a three dimensional schematic view of a pneumatic tool according to one embodiment of the present disclosure.

FIG. 2A shows one cross-sectional view of the pneumatic tool of FIG. 1 taken alone Line 2-2.

FIG. 2B shows another cross-sectional view of the pneumatic tool of FIG. 1 taken alone Line 2-2.

FIG. 3 shows a cross-sectional view of the pneumatic tool of FIG. 2A taken alone Line 3-3.

FIG. 4 shows a cross-sectional view of the pneumatic tool of FIG. 2A taken alone Line 4-4.

FIG. 5 shows a cross-sectional view of a pneumatic tool according to another embodiment of the present disclosure.

FIG. 6 shows a cross-sectional view of a pneumatic tool according to yet another embodiment of the present disclosure.

### DETAILED DESCRIPTION

It will be understood that when an element (or mechanism or module) is referred to as being “disposed on”, “connected to” or “coupled to” another element, it can be directly disposed on, connected or coupled to the other elements, or it can be indirectly disposed on, connected or coupled to the other elements, that is, intervening elements may be present. In contrast, when an element is referred to as be “directly disposed on”, “directly connected to” or “directly coupled to” another element, there are no intervening elements present.

In addition, the terms first, second, third, etc. are used herein to describe various elements or components, these elements or components should not be limited by these terms. Consequently, a first element or component discussed below could be termed a second element or component.

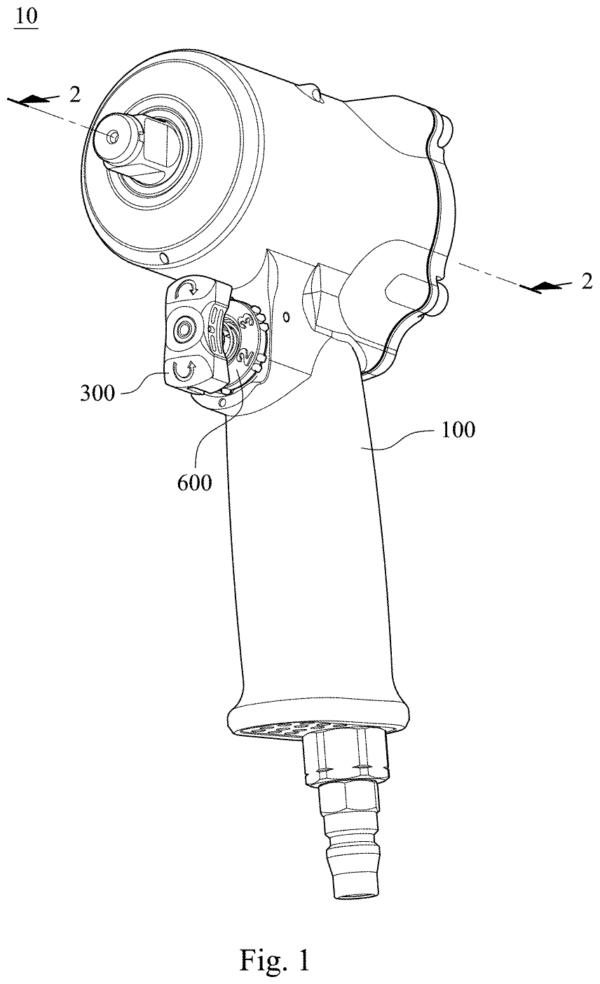

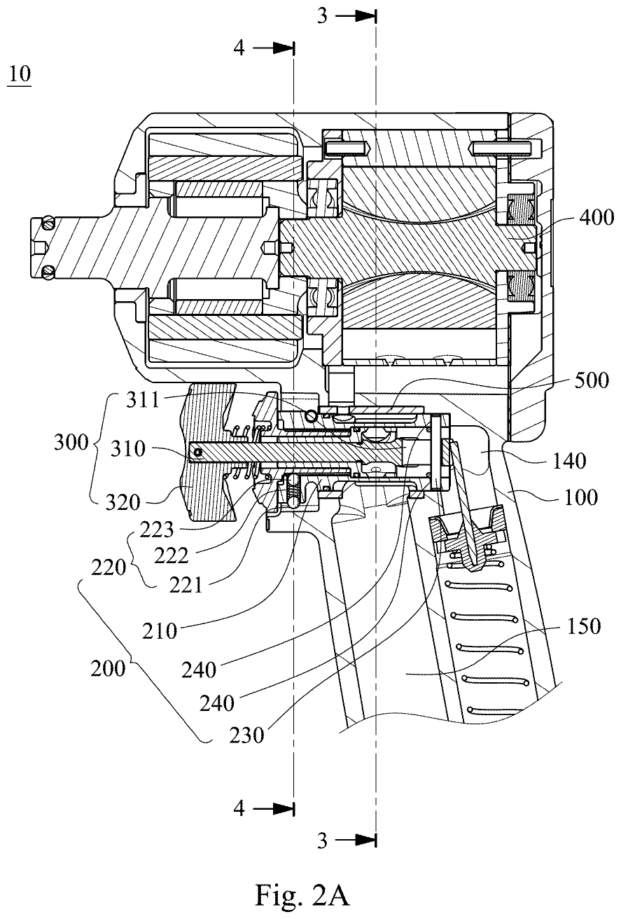

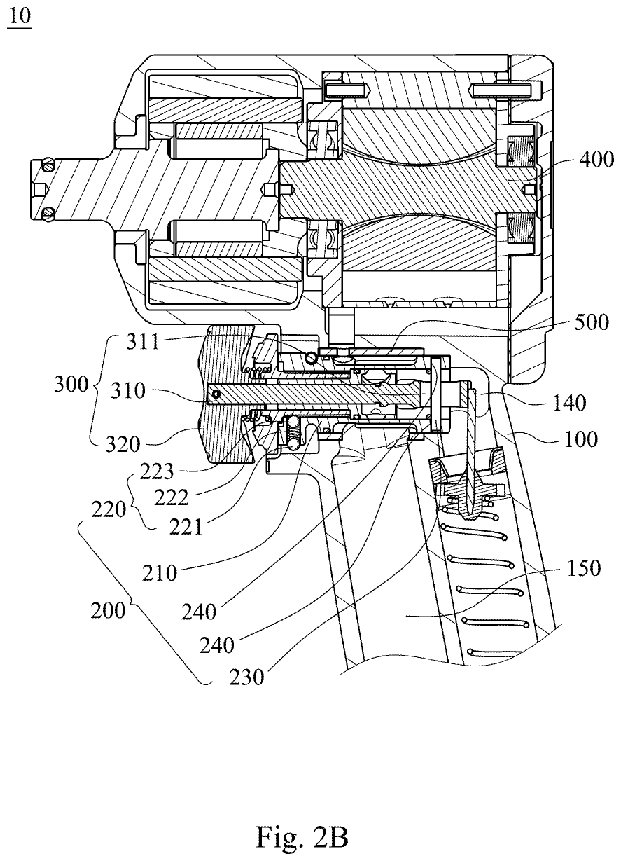

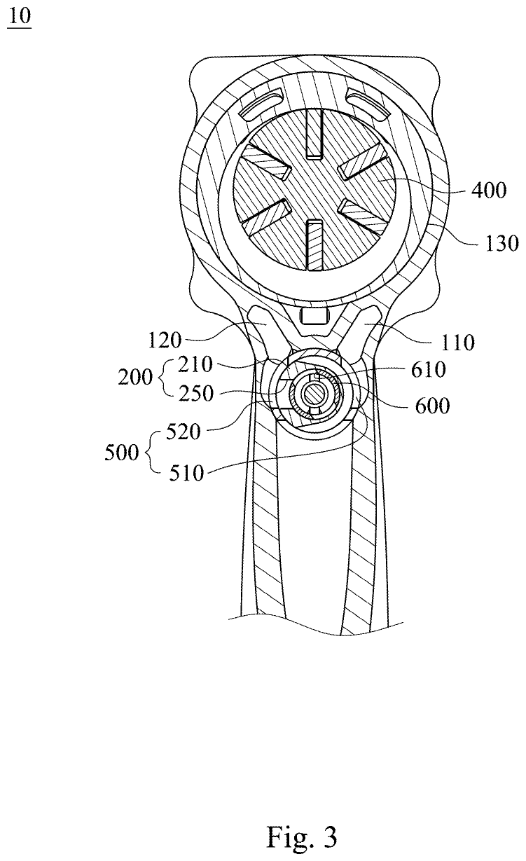

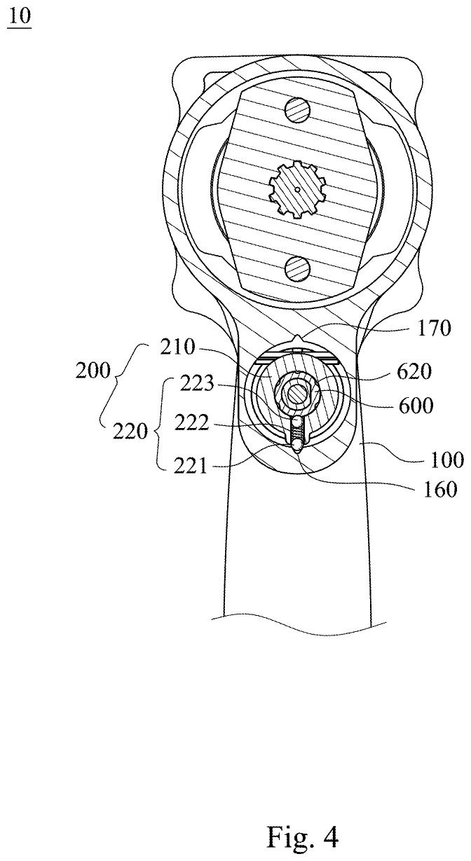

FIG. 1 shows a three dimensional schematic view of a pneumatic tool 10 according to one embodiment of the present disclosure. FIG. 2A shows one cross-sectional view of the pneumatic tool 10 of FIG. 1 taken alone Line 2-2. FIG. 2B shows another cross-sectional view of the pneumatic tool 10 of FIG. 1 taken alone Line 2-2. FIG. 3 shows a cross-sectional view of the pneumatic tool 10 of FIG. 2A taken alone Line 3-3. FIG. 4 shows a cross-sectional view of the pneumatic tool 10 of FIG. 2A taken alone Line 4-4. As shown in FIGS. 1 to 4, the pneumatic tool 10 includes a gun body 100, a motor 400, a rotating valve 200 and a trigger set 300.

The gun body 100 includes a receiving space 130, a first gas channel 110 and a second gas channel 120. The first gas channel 110 and the second gas channel 120 communicate with the receiving space 130, respectively. The motor 400 is received in the receiving space 130. The rotating valve 200 is disposed at the gun body 100 and includes at least one opening 250. The trigger set 300 is operably disposed at the gun body 100 and is operably coupled to the rotating valve 200. A rotation of the trigger set 300 causes the rotating valve 200 to rotate to a first position such that the at least one opening 250 of the rotating valve 200 communicates with the first gas channel 110, and pressing the trigger set 300 allows a gas to enter the first gas channel 110 from the at least one opening 250 thereby driving the motor 400 to rotate in a clockwise direction. The rotation of the trigger set 300 causes the rotating valve 200 to rotate to a second position such that the at least one opening 250 of the rotating valve 200 communicates with the second gas channel 120, and pressing the trigger set 300 allows the gas to enter the second gas channel 120 from the at least one opening 250 thereby driving the motor 400 to rotate in a counterclockwise direction.

Hence, through the configuration, the trigger set 300 can perform functions of mode switch and activating; therefore, no other elements are needed for switching the modes and the convenience and the fluency of the pneumatic tool 10 can be improved. The details of the pneumatic tool 10 will be described hereafter.

The gun body 100 is hollow and thus includes the receiving space 130. The gun body 100 includes an inlet 140 and an outlet 150. The gas can enter the gun body 100 from the inlet 140 and leave the receiving space 130 from the outlet 150. The structure thereof is conventional and is not the improved feature of the present disclosure; consequently, no further description is needed. The gun body 100 can further include a disposing bore (not labeled) configured for the rotating valve 200 to be disposed thereon, and the disposing bore communicates with the inlet 140 and the outlet 150.

In the embodiment shown in FIGS. 1 to 4, a number of the at least one opening 250 is one. Nevertheless, the number of the openings can be more than one in other embodiments, and the present disclosure is not limited thereto. The rotating valve 200 can include a tube 210, and the tube 210 can include an axial channel (not labeled). The opening 250 radially penetrates the tube 210 to communicate with the axial channel. Hence, when the opening 250 communicates with the first gas channel 110, the gas enters the axial channel from the inlet 140 and flows into the receiving space 130 via the opening 250 and the first gas channel 110; as a result, the motor 400 can be driven by the gas to rotate in the clockwise direction. On the contrary, when the opening 250 communicates with the second gas channel 120, the gas enters the axial channel from the inlet 140 and flows into the receiving space 130 via the opening 250 and the second gas channel 120; as a result, the motor 400 can be driven by the gas to rotate in the counterclockwise direction.

The rotating valve 200 can further include a linkage pin 230. The trigger set 300 can include a trigger lever 310, and a rotation of the trigger lever 310 drives the linkage pin 230 to rotate the rotating valve 200. The trigger lever 310 can include a rail 311, and the rail 311 radially penetrates a lever body (not labeled) of the trigger lever 310. The rotating valve 200 can further include two pin holes 240 arranged symmetrically. The linkage pin 230 inserts into the two pin holes 240 and is limited by the rail 311. When the trigger set 300 is pressed, the linkage pin 230 moves within the rail 311 and the rotating valve 200 is not affected by the linkage pin 230.

Precisely, the trigger set 300 includes a trigger 320 and the trigger lever 310. One end of the trigger lever 310 is connected to the trigger 320 along an axial direction, and the trigger lever 310 is moved when the trigger 320 is pressed or rotated. The rail 311 locates at the other end of the trigger lever 310. The rail 311 can have an oval cross-sectional shape along the axial direction, but the present disclosure is not limited thereto.

The tow pin holes 240 locate at one end of the tube 210. As the trigger lever 310 inserts into the axial channel of the tube 210, the two pin holes 240 will correspond to the rail 311, and then the linkage pin 230 can be inserted into the two pin holes 240.

In order to remain the position of the rotating valve 200, the gun body 100 can include two positioning grooves 160 and 170. The rotating valve 200 can further include a restricting member 220. When the rotating valve 200 is in the first position, the restricting member 220 is limited in the positioning groove 160, and when the rotating valve 200 is in the second position, the restricting member 220 is limited in the positioning groove 170.

As shown in FIG. 4, the positioning groove 160 and the positioning groove 170 are located in the inner wall of the disposing bore with an interval of 180 degrees. The positioning grooves 160 and 170 can locate at a position where the trigger 320 is straight. The rotating valve 200 can include a radial hole (not labeled) locating on the tube 210. The restricting member 220 is disposed in the radial hole. The restricting member 220 can include two balls 221 and 223 and a spring 222. The spring 222 abuts between the two balls 221 and 223. Since the spring 222 is elastic, when the rotating valve 200 is rotated, the ball 221 can be urged into the radial hole to allow relative rotation between the rotating valve 200 and the gun body 100. After the rotating valve 200 rotates to a predetermined position and the ball 211 corresponds to the positioning groove 160 or the positioning groove 170, the ball 221 is urged by the spring 222 into the positioning groove 160 or the positioning groove 170 to complete position.

As shown in FIG. 3, the pneumatic tool 10 can further include a valve bushing 500. The valve bushing 500 sleeves the rotating valve 200 and includes two ports 510 and 520. A rotation of the trigger set 300 causes the rotating valve 200 to rotate to the first position relative to the valve bushing 500 such that the opening 250 of the rotating valve 200 is aligned to the port 510, and a rotation of the trigger set 300 causes the rotating valve 200 to rotate to the second position relative to the valve bushing 500 such that the opening 250 of the rotating valve 200 is aligned to the port 520.

The valve bushing 500 is also disposed at the disposing bore of the gun body 100. The port 510 communicates with the first gas channel 110, and the port 520 communicates with the second gas channel 120. Hence, as the opening 250 of the rotating valve 200 is aligned to the port 510, the opening 250 can communicate with the first gas channel 110. On the contrary, as the opening 250 of the rotating valve 200 is aligned to the port 520, the opening 250 can communicate with the second gas channel 120.

The pneumatic tool 10 can further include an adjusting valve 600 which inserts into the axial channel of the rotating valve 200 and includes two adjusting holes 610. The relationship between the adjusting holes 610 and the opening 250 can be changed by a rotation of the adjusting valve 600 relative to the rotating valve 200. As the adjusting hole 610 totally corresponds to the opening 250, the amount of the gas is large such that the speed of the pneumatic tool 10 is high, and as the adjusting hole 610 partially corresponds to the opening 250, the amount of the gas is small such that the speed of the pneumatic tool 10 is low. Moreover, in the embodiment shown in FIGS. 1 to 4, the pneumatic tool 10 can be switched between three speed settings. Furthermore, the adjusting valve 600 can further include a plurality of outer caves 620 corresponding to the restricting member 220. The ball 223 can be limited in one of the outer caves 620 to remain the position of the adjusting valve 600 relative to the rotating valve 200.

During operation, a user can rotate the trigger 320 to cause a rotation of the trigger lever 310, and since the linkage pin 230 inserts into the pin holes 240 and the rail 311, the linkage pin 230 is moved with the trigger lever 310 such that the rotating valve 200 is rotated relative to the gun body 100 and the valve bushing 500 to switch between the first position and the second position, thereby changing the rotating direction of the pneumatic tool 10. In addition, as shown in FIG. 4, the rotating valve 200 can be positioned by the restricting member 220 and be remained in the predetermined position.

Subsequently, the user can rotate the adjusting valve 600 to adjust the speed of the pneumatic tool 10, and the relative position between the adjusting valve 600 and the rotating valve 200 can be remained by the restricting member 220.

As shown in FIG. 2B, the user can then press the trigger 320 to allow the trigger lever 310 to move axially, and since the linkage pin 230 can limitedly move in the rail 311, axial movement of the trigger lever 310 cannot cause a rotation of the rotating valve 200, but the trigger lever 310 can push a valve rod (not shown) in the gun body 100 to activate the pneumatic tool 10. As the trigger 320 is released by the user, the trigger 320 returns to the initial position as shown in FIG. 2A.

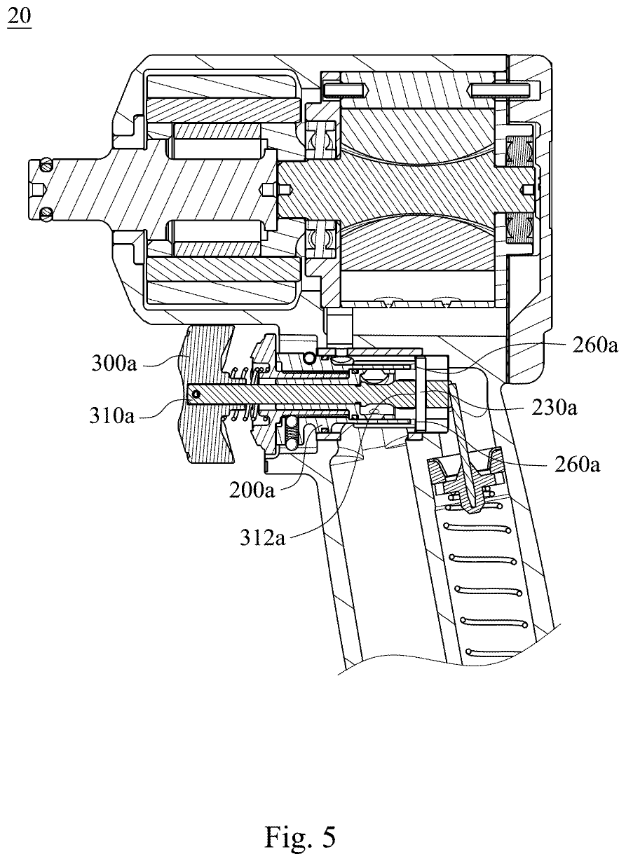

FIG. 5 shows a cross-sectional view of a pneumatic tool 20 according to another embodiment of the present disclosure. The pneumatic tool 20 is similar to the pneumatic tool 10 shown in FIGS. 1 to 4. The difference therebetween will be described hereafter, and the same structure will not be mentioned.

The trigger set 300a includes a trigger lever 310a, and the trigger lever 310a includes a through hole 312a. The rotating valve 200a further includes a linkage pin 230a and two guiding rails 260a arranged symmetrically. The linkage pin 230a inserts into the through hole 312a and is limited by the guiding rails 260a. When the trigger set 300a is rotated, the trigger lever 310a drives the linkage pin 230a to rotate the rotating valve 200a, and when the trigger set 300a is pressed, the linkage pin 230a is moved by the trigger lever 310a within the guiding rails 260a and the rotating valve 200a is not affected by the linkage pin 230a.

In other words, the linkage pin 230a is secured in the through hole 312a and can limitedly and axially move within the two guiding rails 260a; consequently, a rotation of the trigger lever 310a can cause a rotation of the rotating valve 200a, but axial movement of the trigger lever 310a cannot cause a rotation of the rotating valve 200a.

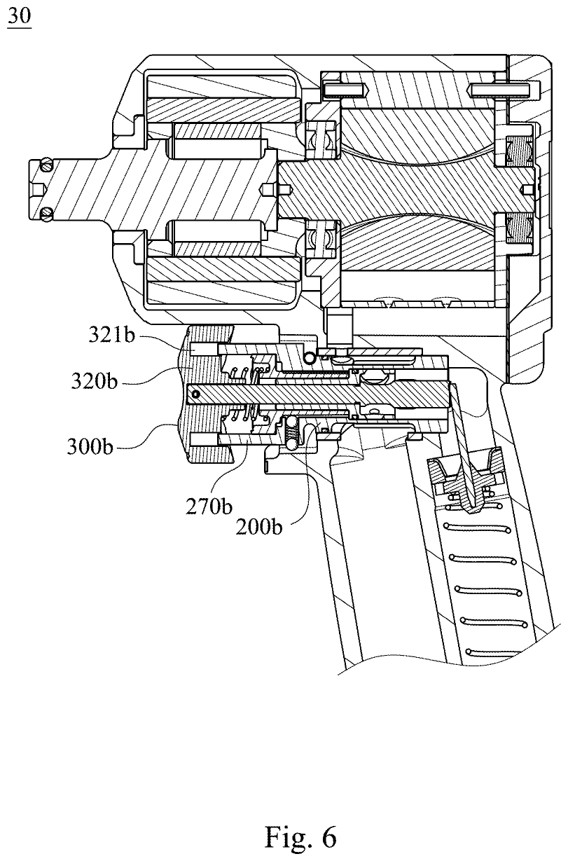

FIG. 6 shows a cross-sectional view of a pneumatic tool 30 according to yet another embodiment of the present disclosure. The pneumatic tool 30 is similar to the pneumatic tool 10 shown in FIGS. 1 to 4. The difference therebetween will be described hereafter, and the same structure will not be mentioned.

The trigger set 300b includes at least one linkage groove 321b. The rotating valve 200b further includes at least one linkage lever 270b, and the at least one linkage lever 270b is coupled to the at least one linkage groove 321b. When the trigger set 300b is rotated, a rotation of the at least one linkage lever 270b causes a rotation of the rotating valve 200b, and when the trigger set 300b is pressed, the at least one linkage lever 270b is limited moved within the at least one linkage groove 321b.

As shown in FIG. 6, a number of the linkage grooves 321b is two and the linkage grooves 321b are axially disposed at the trigger 320b. A number of the linkage levers 270b corresponds to the amount of the linkage grooves 321b, and each of the linkage levers 270b protrudes axially outward from one end of the tube (not labeled) of the rotating valve 200b. The diameter of each of the linkage grooves 321b is substantially equal to the diameter of each of the linkage levers 270b; hence, after each of the linkage levers 270b is received in each of the linkage grooves 321b, each of the linkage levers 270b can do axial movement but not radial movement relative to each of the linkage grooves 321b.

Therefore, a rotation of the trigger 320b causes a rotation of the rotating valve 200b, and pressing the trigger 320b causes axial movement of the linkage lever 270b relative to the linkage groove 321b; as a result, the rotating valve 200b will not rotate. In other embodiment, the trigger set can include at least one linkage lever and the rotating valve can include at least one linkage groove. The present disclosure is not limited thereto.

Please be noted that, the structure that rotate the trigger set 180 degrees to switch rotating mode can be simplified to be used in an electrical tool.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A pneumatic tool, comprising:
a gun body;
a rotating valve disposed at the gun body and comprising at least one opening;
a valve bushing sleeving the rotating valve and comprising two ports; and
a trigger set operably disposed at the gun body and operably coupled to the rotating valve;
wherein a rotation of the trigger set causes the rotating valve to rotate to a first position relative to the valve bushing such that the at least one opening of the rotating valve is aligned to one of the two ports; the rotation of the trigger set causes the rotating valve to rotate to a second position relative to the valve bushing such that the at least one opening of the rotating valve is aligned to the other one of the two ports.

2. The pneumatic tool of claim 1, wherein the gun body comprises two positioning grooves, and the rotating valve further comprises a restricting member; when the rotating valve is in the first position, the restricting member is limited in one of the positioning grooves; when the rotating valve is in the second position, the restricting member is limited in the other one of the positioning grooves.

3. The pneumatic tool of claim 1, wherein the rotating valve further comprises a linkage pin, the trigger set comprises a trigger lever, and a rotation of the trigger lever drives the linkage pin to rotate the rotating valve.

4. The pneumatic tool of claim 3, wherein the trigger lever comprises a rail, the rail radially penetrates a lever body of the trigger lever, the rotating valve further comprises two pin holes arranged symmetrically, and the linkage pin inserts into the two pin holes and is limited by the rail; when the trigger set is rotated, the linkage pin is moved by the trigger lever to rotate the rotating valve; when the trigger set is pressed, the linkage pin moves within the rail and the rotating valve is not affected by the linkage pin.

5. The pneumatic tool of claim 3, wherein the trigger lever comprises a through hole, the rotating valve further comprises two guiding rail arranged symmetrically, and the linkage pin inserts into the through hole and is limited by the guiding rails; when the trigger set is rotated, the trigger lever drives the linkage pin to rotate the rotating valve; when the trigger set is pressed, the linkage pin is moved by the trigger lever within the guiding rails and the rotating valve is not affected by the linkage pin.

6. The pneumatic tool of claim 1, wherein the trigger set comprises at least one linkage groove, the rotating valve further comprises at least one linkage lever, and the at least one linkage lever is coupled to the at least one linkage groove; the rotation of the trigger set causes a rotation of the at least one linkage lever to rotate the rotating valve; when the trigger set is pressed, the at least one linkage lever is limited moved within the at least one linkage groove.

7. A pneumatic tool, comprising:
a gun body, comprising:
a receiving space; and
a first gas channel and a second gas channel communicating with the receiving space, respectively;
a motor received in the receiving space;
a rotating valve disposed at the gun body and comprising at least one opening; and
a trigger set operably disposed at the gun body and operably coupled to the rotating valve;
wherein a rotation of the trigger set causes the rotating valve to rotate to a first position such that the at least one opening of the rotating valve communicating with the first gas channel, pressing the trigger set allows a gas to enter the first gas channel from the at least one opening thereby driving the motor to rotate in a clockwise direction, the rotation of the trigger set causes the rotating valve to rotate to a second position such that the at least one opening of the rotating valve communicating with the second gas channel, and pressing the trigger set allows the gas to enter the second gas channel from the at least one opening thereby driving the motor to rotate in a counterclockwise direction.

8. The pneumatic tool of claim 7, wherein the gun body comprises two positioning grooves, and the rotating valve further comprises a restricting member; when the rotating valve is in the first position, the restricting member is limited in one of the positioning grooves; when the rotating valve is in the second position, the restricting member is limited in the other one of the positioning grooves.

9. The pneumatic tool of claim 7, wherein the trigger set comprises at least one linkage groove, the rotating valve further comprises at least one linkage lever, and the at least one linkage lever is coupled to the at least one linkage groove; the rotation of the trigger set causes a rotation of the at least one linkage lever to rotate the rotating valve; when the trigger set is pressed, the at least one linkage lever is limited moved within the at least one linkage groove.

10. The pneumatic tool of claim 7, wherein the trigger set comprises a trigger lever, the trigger lever comprises a rail, the rail radially penetrates a lever body of the trigger lever, the rotating valve further comprises two pin holes arranged symmetrically, and the linkage pin inserts into the two pin holes and is limited by the rail; when the trigger set is pressed, the linkage pin moves within the rail and the rotating valve is not affected by the linkage pin.

11. The pneumatic tool of claim 7, wherein the trigger set comprises a trigger lever, the trigger lever comprises a through hole, the rotating valve further comprises two guiding rail arranged symmetrically, and the linkage pin inserts into the through hole and is limited by the guiding rail; when the trigger set is rotated, the trigger lever drives the linkage pin to rotate the rotating valve; when the trigger set is pressed, the linkage pin is moved by the trigger lever within the guiding rail and the rotating valve is not affected by the linkage pin.
